(19) United States
(12) Patent Application Publication
(10) Pub. No.: US 2009/0328233 A1
(43) Pub. Date: Dec. 31, 2009

(54) SENDING LOG OF ACCESSED DATA PRIOR TO EXECUTING DISABLE COMMAND IN LOST COMPUTER

(75) Inventors: Howard Jeffrey Locker, Cary, NC (US); Richard Wayne Cheston, Morrisville, NC (US); Daryl Carvis Cromer, Cary, NC (US)

Correspondence Address: ROGITZ & ASSOCIATES, 750 B STREET, SUITE 3120, SAN DIEGO, CA, 92101, US

(73) Assignee: Lenovo (Singapore) Pte, Ltd.

(21) Appl. No.: 12/146,210

(22) Filed: Jun. 25, 2008

(51) Int. Cl. H04L 9/00

(52) U.S. Cl. 726/27

(57) ABSTRACT

Prior to disabling itself in response to a disable command, a lost or stolen portable computer first constructs a log of data that has been accessed recently and sends the log to the rightful owner's address, so the owner knows specifically what data might have been compromised.

I. Field of the Invention

The present invention relates generally to sending a log of data that was accessed since a benchmark time from a portable computer prior to disabling the computer because it is lost or stolen.

II. Background of the Invention

Portable computers may be provided with a mechanism to disable the computer if the rightful owner has lost the computer or suspects it of being stolen, to prevent access to potentially sensitive information on the computer. As understood herein, however, without knowing for sure what data was compromised prior to sending the disable command, the rightful owner must presume that all data was compromised and take action accordingly, including, for example, sending out notifications to people whose data may have been stored on the computer.

### SUMMARY OF THE INVENTION

A method includes receiving a disable command at a computer and in response to the disable command, transmitting information indicating accessed data. After transmission of the information, the computer disables itself.

In another aspect, a portable computer includes a portable housing, a processor in the housing, and a tangible computer readable storage medium in the housing and accessible to the processor. The medium bears information. A transceiver is in the housing and is configured to receive a disable command and in response transmit a log of data that has been accessed, prior to executing the disable command.

The log may be, e.g., of data accessed since a benchmark time that may be identified in the disable command. If desired, the log can indicate data that has been read and data that has been written. The disable command can cause the computer to render itself substantially unusable. Without limitation, the log may contain file names that have been accessed since the benchmark time.

In another aspect, a computer includes a processor executing logic including generating a disable command that includes an address to which a log of recently accessed data is to be sent, an address of a computer sought to be disabled, and instruction to the computer sought to be disabled to disable itself after sending a log of recently accessed data to the address to which the log of accessed data is to be sent.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a non-limiting block diagram of an example system in accordance with present principles; and

FIG. 2 is a non-limiting flow chart showing example logic that can be used in accordance with present principles.

### DETAILED DESCRIPTION OF THE PREFERRED EMBODIMENT

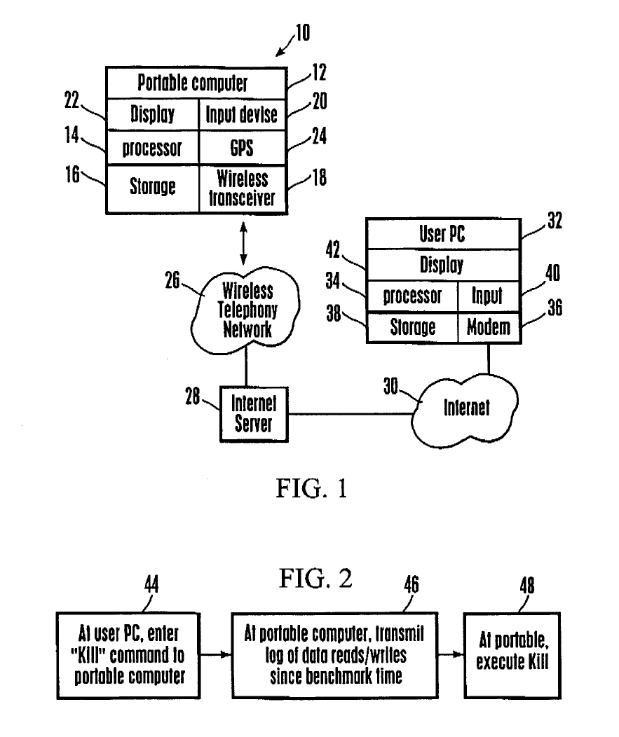

Referring initially to FIG. 1, a portable computer 10 such as, e.g., a personal digital assistant (PDA) or notebook computer or laptop computer includes a portable hand-held housing 12 holding a processor 14 and tangible computer readable storage medium 16 such as but not limited to disk storage, solid state storage, etc. The storage medium 16 can bear data, as well as logic executable by the processor 14 pursuant to logic set forth herein. Among other things, the processor 14 can execute a software agent that maintains a running log of files that have been read and files that have been written to in a most recent period, e.g., within the most recent week, or day, etc. Preferably, for reasons that will become clear after description below, the log is encrypted/hashed.

The processor 14 communicates with a wireless telephony transceiver 18 within the housing 12 to send and receive wireless signals. The transceiver 18 may be, without limitation, a global system for mobile communication (GSM) transceiver, code division multiple access (CDMA) transceiver or variant such as wideband-CDMA, a TDMA or FDMA or SDMA transceiver, an orthogonal frequency division multiplexing (OFDM) transceiver, etc. The processor 14 may receive input from a user input device 20 such as a keypad and/or mouse and/or joystick, etc. and may provide output to an output device 22 such as a computer monitor. The processor 14 may receive position signals from a position receiver 24 such as a global positioning satellite (GPS) receiver.

Using the transceiver 18, the portable computer 10 may communicate with a wireless telephony network 26, which in turn can communicate with wide area computer servers 28 (only a single server 28 shown for clarity) on the Internet 30. The rightful owner (also referred to as “user” or, equivalently, an authorized agent such as a third party information technology administrator) of the portable computer 10 may also be the user of a user computer 32 with processor 34 communicating, via a modem 36, with the Internet 30. The processor 34 of the user computer 32 can access a tangible computer readable storage medium 38 such as but not limited to disk storage, solid state storage, etc. The storage medium 38 can bear data, as well as logic executable by the processor 34 pursuant to logic set forth herein.

The processor 34 may receive input from a user input device 40 such as a keypad and/or mouse and/or joystick, etc. and may provide output to an output device 42 such as a computer monitor.

FIG. 2 shows that if the user loses the portable computer 10 or suspects it of being stolen, at block 44 the user or authorized agent can enter, at the user computer 32, a disable (“kill”) command that is sent to the portable computer 12 via the Internet 30 and telephony (or wide area) network 26. As part of the disable command, which may be sent as one or more data packets or as a short message service (SMS) command or equivalent, the destination address (e.g., Internet Protocol address) of the desired recipient of the log can be included. Also, the user may be permitted to identify as part of the command a benchmark time, typically the time at which the user suspects the portable computer to have been lost or stolen, after which any read or written data is desired to be indicated in the below-described log. If desired, the disable command may be encrypted for authentication by the portable computer to ensure an authorized sender in accordance with means known in the art, e.g., using private-public key encryption.

In accordance with present principles, prior to disabling itself, at block 46 the portable computer 10 determines a benchmark time (e.g., a predetermined period such as the previous twelve hours, previous twenty four hours, etc. or the above-mentioned user-defined time in the “disable” message) and accesses the above-described running log of data that has been accessed since that time, sending the log to, e.g., the address of the user computer 32 or to another address such as that of the server 28, which can then provide the log to the user of the computer for a service fee if desired. The address to which the log is sent may be included in the disable command. The log may indicate data on the storage medium 16 that has been read and data that has been written.

In one implementation the log indicates logical block addresses (LBAs) of accessed data, with the user computer 32 having been synchronized with the portable computer 10 to contain a listing of LBAs versus file information so that the user computer 32 can use the log to present a list of files on the user computer display 42. Or, the log may include file names (including, if desired, not only file names but also directory path names). Yet again, the log may include the actual data that was accessed so that even if the user cannot correlate LBAs or remember what was contained in a particular file name, the user will know the actual data that was accessed in the portable computer 10 since the benchmark time. The log may contain a combination of the above example data forms. Because the log can be preferably encrypted and/or hashed, a recipient holding the encryption/hash keys can ascertain whether the log was tampered with and if so, can assume that all data in the portable computer has been compromised.

Once the log has been transmitted, the portable computer 10 executes the disable command at block 48. By way of non-limiting example, to disable itself the basic input-output system (BIOS) of the portable computer 10 can simply modify itself to prevent booting the main operating system or otherwise refuse to boot. Or, the portable computer 10 can delete all of the files in the storage medium 16. Present principles are not limited to the particular disable mechanism used.

While the particular SENDING LOG OF ACCESSED DATA PRIOR TO EXECUTING DISABLE COMMAND IN LOST COMPUTER is herein shown and described in detail, it is to be understood that the subject matter which is encompassed by the present invention is limited only by the claims.

What is claimed is:

1. A portable computer, comprising:
a portable housing;
a processor in the housing;
a tangible computer readable storage medium in the housing and accessible to the processor and bearing information;
a transceiver in the housing configured to receive a disable command and in response transmit a log of data that has been accessed, prior to executing the disable command.

2. The computer of claim 1, wherein the log is of data accessed since a benchmark time.

3. The computer of claim 2, wherein the log indicates data that has been read and data that has been written.

4. The computer of claim 1, wherein the disable command causes the computer to render itself substantially unusable.

5. The computer of claim 2, wherein the benchmark time is identified in the disable command.

6. The computer of claim 2, wherein the log contains at least file names that have been accessed since the benchmark time.

7. Computer, comprising:
at least one processor executing logic comprising generating a disable command, the disable command including at least:
an address to which a log of recently accessed data is to be sent;
an address of a computer sought to be disabled; and
instruction to the computer sought to be disabled to disable itself after sending a log of recently accessed data to the address to which the log of accessed data is to be sent.

8. Computer of claim 7, wherein the disable command is encrypted.

9. Computer of claim 7, wherein the address to which the log of accessed data is to be sent is an address of the computer sending the disable command.

10. Computer of claim 7, wherein the address to which the log of accessed data is to be sent is an address of an Internet server.

11. Computer of claim 7, wherein the disable command further includes a benchmark time.

12. Method, comprising:
receiving a disable command at a computer;
in response to the disable command, transmitting information indicating accessed data; and
after the transmitting act, disabling the computer.

13. The method of claim 12, wherein the computer disables itself.

14. The method of claim 12, wherein the information indicating accessed data indicates data accessed since a benchmark time.

15. The method of claim 14, wherein the benchmark time is defined in the disable command.

16. The method of claim 12, wherein the information is transmitted to an address identified in the disable command.

17. The method of claim 12, wherein the information indicates data that has been read and data that has been written.

18. The method of claim 12, wherein the disable command causes the computer to
render itself substantially unusable.
